(19) United States
(12) Patent Application Publication
(10) Pub. No.: US 2004/0177117 A1
(43) Pub. Date: Sep. 9, 2004

(54) Method of sharing multimedia

(76) Inventor: Chang-Shun Huang, Taipei (TW)

Correspondence Address: BIRCH STEWART KOLASCH & BIRCH, PO BOX 747, FALLS CHURCH, VA, 22040-0747, US

(21) Appl. No.: 10/379,599

(22) Filed: Mar. 6, 2003

(51) Int. Cl. G06F 15/16; G09G 5/00

(52) U.S. Cl. 709/206; 345/748

(57) ABSTRACT

A method of sharing multimedia. The method comprises the steps of obtaining multimedia files, storing a template providing a display area for the multimedia files, integrating the multimedia files and the template into an email message, transmitting the email message from a sender to a recipient, and opening the multimedia files in the display area provided by the template when the email message is opened by the recipient.

### BACKGROUND OF THE INVENTION

1. Field of the Invention

The present invention relates to multimedia sharing and particularly to a method of sharing multimedia making it convenient for an email message recipient to view multimedia files contained in email messages.

2. Description of the Prior Art

As the Internet becomes more and more popular, email messages have become a common tool for information exchange. Text messages, attached files and video clips are transferred via email messages. The sender must have a software application to edit and send email messages to a recipient using the same or another email message application. The sender and recipient can also exchange email messages by the same exchange protocol.

Conventionally, email message applications only allow users to write text messages and multimedia files must be attached, rather than being part of the actual message. When such an email message is sent and opened by the recipient, the text messages appear and a symbol indicates that files are attached. The recipient must use one or more software applications such as Outlook, Web mail, IA device mail receiver application . . . etc., to open the attached files one by one.

However, it is troublesome to open the attached files, especially when there are several. The recipient must use a corresponding application to open the attached files. The inconvenience is compounded when receiving the message on IA devices, such as a PDA or Mobile Phone.

### SUMMARY OF THE INVENTION

The object of the present invention is to provide a method of sharing multimedia making it convenient for an email message recipient to view multimedia files contained in the email message.

The present invention provides a method of sharing multimedia comprising the steps of obtaining a multimedia file, storing a template providing a display area for the multimedia file, integrating the multimedia file and the template into an email message, transmission of the email message from a sender to a recipient, and opening the multimedia file in the display area provided by the template when the email message is opened by the recipient.

The present invention further provides an apparatus for multimedia sharing. The apparatus comprises means for obtaining a multimedia file, means for storing a template providing a display area for the multimedia file, means for integrating the multimedia file into the template to construct an email message, means for transmitting the email message from a sender to a recipient, and means for opening the multimedia file in the display area provided by the template when the email message is opened by the recipient.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a flowchart of a method of sharing multimedia according to one embodiment of the invention.

FIG. 2˜7 show examples of the templates used in one embodiment of the invention.

### DETAILED DESCRIPTION OF THE INVENTION

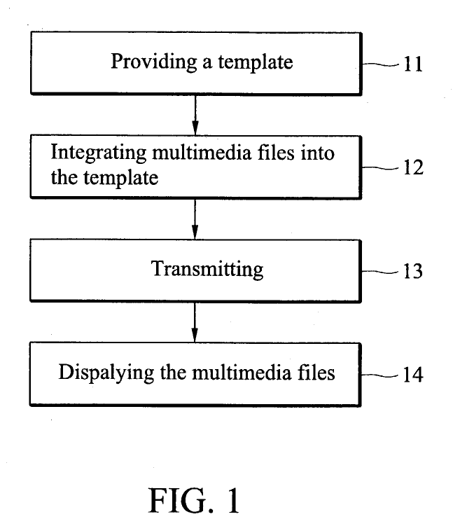

FIG. 1 is a flowchart of a method of sharing multimedia according to one embodiment of the invention.

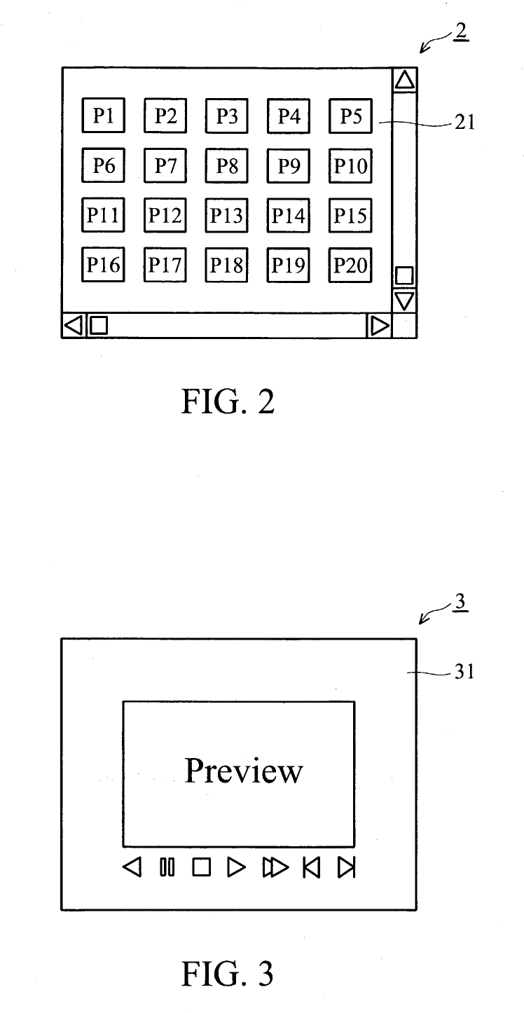

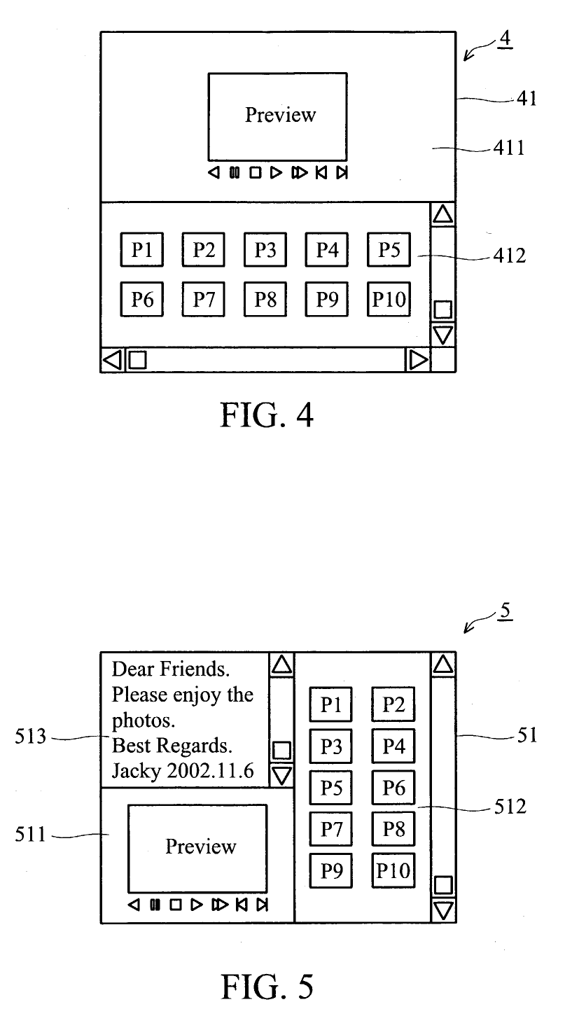

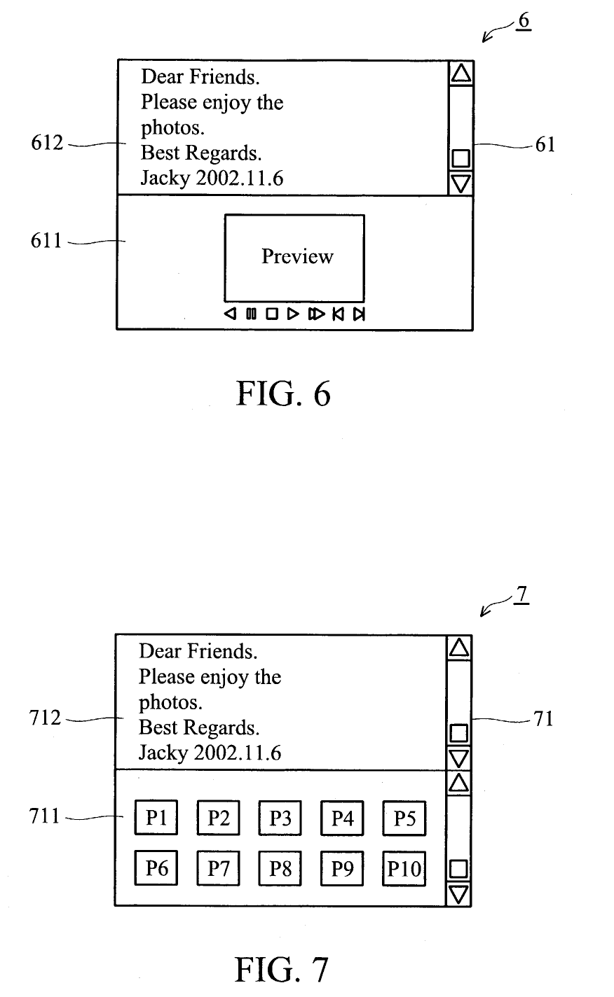

In step 11, templates are pre-stored in the sender. In the templates, there can be 3 basic elements—thumbnails and previews of the multimedia files, and text message area. FIG. 2˜7 show examples of the templates. In FIG. 2, the template 2 has only an area 21 for opening thumbnails. In FIG. 3, the template 3 has only an area 31 for opening previews. In FIG. 4, the template 4 has a frame 41 with sub-frames 411 and 412 respectively for opening the previews and thumbnails of the attached files. In FIG. 5, the template 5 has a frame 51 with sub-frames 511, 512 and 513 respectively for opening the previews and thumbnails of the attached files, and text messages. In FIG. 6, the template 6 has a frame 61 with sub-frames 611 and 612 respectively for opening previews and text messages. In FIG. 7, the template 7 has a frame 71 with sub-frames 711 and 712 respectively for opening thumbnails and text messages.

In step 12, the multimedia files are obtained and integrated into the template to construct an email message. The sender drags and drops the multimedia files onto corresponding areas in the template. The template contained in the email message can be constructed using markup language, such as HTML or XTML, or programming language, such as Java, Script, Flash, C or C++.

In step 13, the email message is transmitted from the sender to the recipient via an exchange protocol therebetween.

In step 14, the multimedia file embedded in the email message is directly opened when the email message is received and opened by the recipient. The multimedia files need not be individually opened using a specific viewer application.

In conclusion, the present invention provides a method of sharing multimedia making it convenient for an email message recipient to view multimedia files contained in the email message. A template is provided with which the email message sender integrates the multimedia files into the template. When the recipient opens the email message, the multimedia files are directly opened with no viewer application needed.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method of sharing multimedia comprising the steps of:
obtaining at least one multimedia file;
storing a template providing a display area for multimedia files;
integrating the at least one multimedia file into the template to construct an email message;
transmitting the email message to a recipient; and
opening the at least one multimedia file in the display area provided by the template when the email message is opened by the recipient.

2. The method as claimed in claim 1, wherein a thumbnail for each multimedia file is opened in the display area.

3. The method as claimed in claim 1, wherein a preview of each multimedia file is opened in the display area.

4. The method as claimed in claim 1, wherein the display area is a frame having two sub-frames respectively for opening thumbnails and previews for each multimedia file.

5. The method as claimed in claim 1, wherein the display area is a frame having three sub-frames respectively for opening messages, and thumbnails and previews for each multimedia file.

6. The method as claimed in claim 1, wherein the display area is a frame having two sub-frames respectively for opening messages and a preview of each multimedia file.

7. The method as claimed in claim 1, wherein the display area is a frame having two sub-frames respectively for opening messages and thumbnails for each multimedia file.

8. The method as claimed in claim 1, wherein the template is constructed using markup language.

9. The method as claimed in claim 8, wherein the markup language is HTML or XTML.

10. The method as claimed in claim 1, wherein the template is constructed using programming language.

11. The method as claimed in claim 10, wherein the programming language is Java, Script, Flash, C or C++.

12. An apparatus for multimedia sharing comprising:
means for obtaining at least one multimedia file;
means for storing a template providing a display area for the at least one multimedia file;
means for integrating the at least one multimedia file into the template to construct an email message;
means for transmitting the email message from a sender to a recipient; and
means for opening the at least one multimedia file in the display area provided by the template when the email message is opened by the recipient.
